(19) United States
(12) Patent Application Publication
(10) Pub. No.: US 2025/0251897 A1
(43) Pub. Date: Aug. 7, 2025

(54) REMOTE VIEWING AND CONTROL OF AN ELECTRONIC DEVICE

(71) Applicant: Apple Inc., Cupertino, CA (US)

(72) Inventors: Dawn J Binder, Mountain View, CA (US); Jihan E Chao, Santa Clara, CA (US); Chien-Ning Chen, San Jose, CA (US); Jessica E Poole, Menlo Park, CA (US); Chensong He, Saratoga, CA (US)

(21) Appl. No.: 19/041,325

(22) Filed: Jan. 30, 2025

Related U.S. Application Data
(60) Provisional application No. 63/548,601, filed on Feb. 1, 2024.

(51) Int. Cl. G06F 3/14

(52) U.S. Cl. CPC G06F 3/1454

(57) ABSTRACT

Various implementations disclosed herein include devices, systems, and methods that provide a device with a portal associated with enabling mirroring and control functionality of a head mounted device (HMD). For example, a process may pair an electronic device with a head mounted device (HMD) such that communications are established between the electronic device and the HMD. The process may further provide mirroring functionality such that content rendered on a display of the HMD is additionally rendered on a display of the electronic device. In response to providing the mirroring functionality, the process may further enable the electronic device to control a specified functionality of the HMD.

### CROSS-REFERENCE TO RELATED APPLICATIONS

This application claims the benefit of U.S. Provisional Application Ser. No. 63/548,601 filed Feb. 1, 2024, which is incorporated herein in its entirety.

### TECHNICAL FIELD

The present disclosure generally relates to an electronic device that provides mirroring and control of a head mounted device (HMD).

### BACKGROUND

Existing systems for assisting a user with operation of a device may be improved with respect to providing specialized and automated instructions for operating various features of the device.

### SUMMARY

Various implementations disclosed herein include devices, systems, and methods that provide an electronic device that enables a specialized demo portal for providing mirroring and control functionality of an HMD such that content rendered on a display of the HMD is additionally rendered on a display of the electronic device thereby allowing an operator of the electronic device to control specified features of the HMD. For example, providing mirroring and control functionality of an HMD may allow a sales associate to help a customer view and learn HMD features. The electronic device may be, for example, a tablet, a mobile device, etc. The content rendered on the display of the HMD and mirrored on the display of the electronic device may include a view of a three-dimensional (3D) environment comprising applications, images, or 3D objects.

In some implementations, the electronic device may control HMD features such as, inter alia, opening and closing applications of the HMD, controlling volume and audio settings of the HMD, controlling environments such as a background, etc. of the HMD, recalibrating HMD features such as hand tracking, gaze tracking, interpupillary distance (IPD), etc.

In some implementations, the mirroring and control functionality may be initialized in response to a request for assistance associated with operation of the HMD. In response, mirroring and control functionality is enabled via an automatic pairing process (between the electronic device and the HMD) that does not require code to be manually entered. The electronic device and the HMD may both be registered with a backend server (e.g., a virtual hub) such that the mirroring and control functionality of the HMD may be initialized via a tap or touch between the electronic device and the HMD. Likewise, the electronic device and the HMD both being registered with a backend server may enable the mirroring and control functionality of the HMD to be initialized by selecting an HMD from a list of proximate HMDs.

In some implementations, the mirroring and control functionality may include multiple modes, such as e.g., a normal consumer mode that includes a set of mirroring features and a demo mode that includes a different set of mirroring features. For example, a mode such as a demo mode (e.g., associated with a demo of a product or process) may only be available with respect to a particular context such as, for example, the HMD being registered as a demo device, located at a retail location, paired via a particular technique, etc.

In some implementations, a device has a processor (e.g., one or more processors) that executes instructions stored in a non-transitory computer-readable medium to perform a method. The method performs one or more steps or processes. In some implementations, the electronic device is paired with an HMD such that communications are established between the electronic device and the HMD. Some implementations provide mirroring functionality such that content rendered on a display of the HMD is additionally rendered on a display of the electronic device. In response to providing the mirroring functionality, the electronic device is enabled to control a specified functionality of the HMD.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

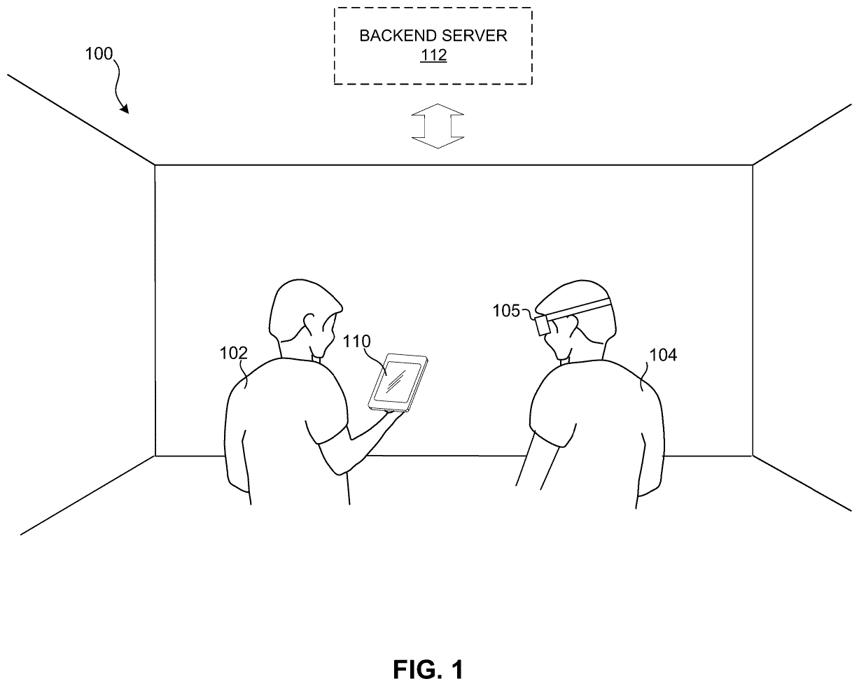

FIG. 1 illustrates exemplary electronic devices operating in a physical environment in accordance with some implementations.

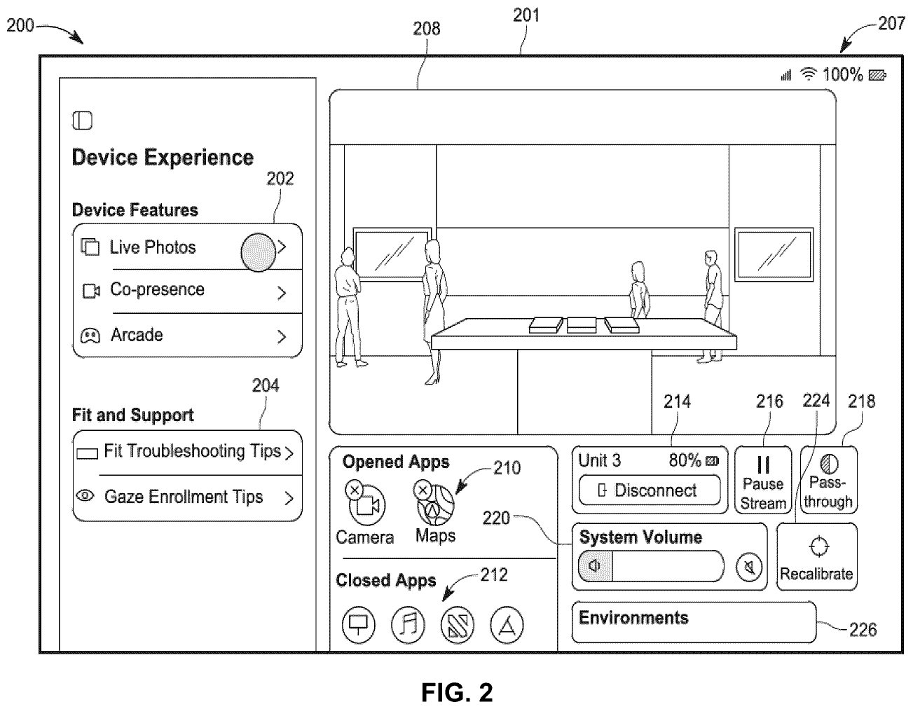

FIG. 2 illustrates an exemplary view of a control interface of an electronic device such as a tablet for enabling control of a device such as an HMD, in accordance with some implementations.

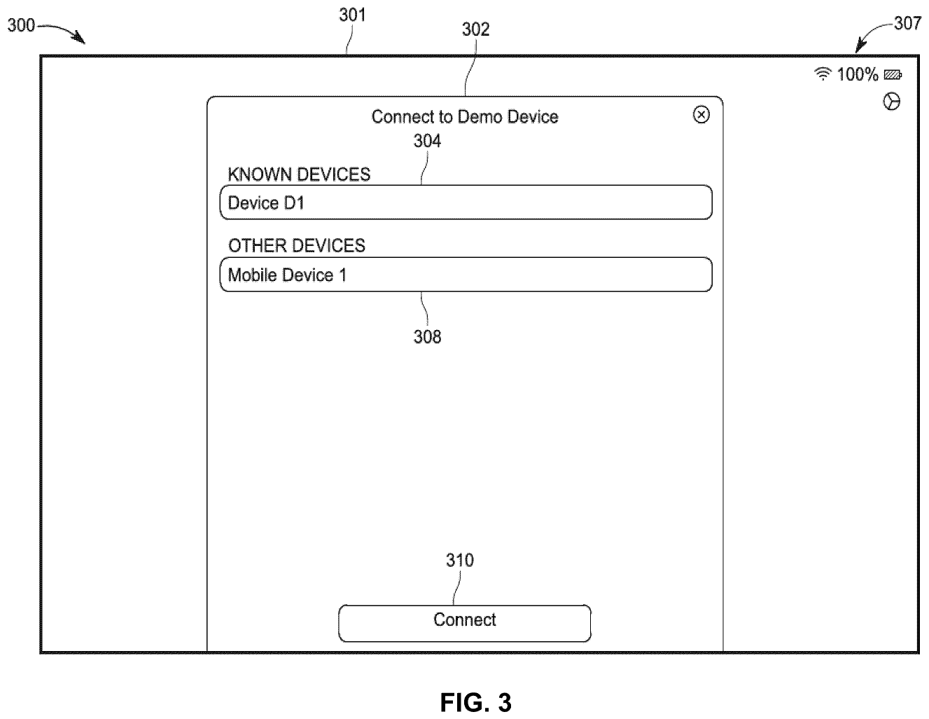

FIG. 3 illustrates an exemplary view of a control interface of an electronic device such as a tablet for enabling a pairing process with a device such as an HMD, in accordance with some implementations.

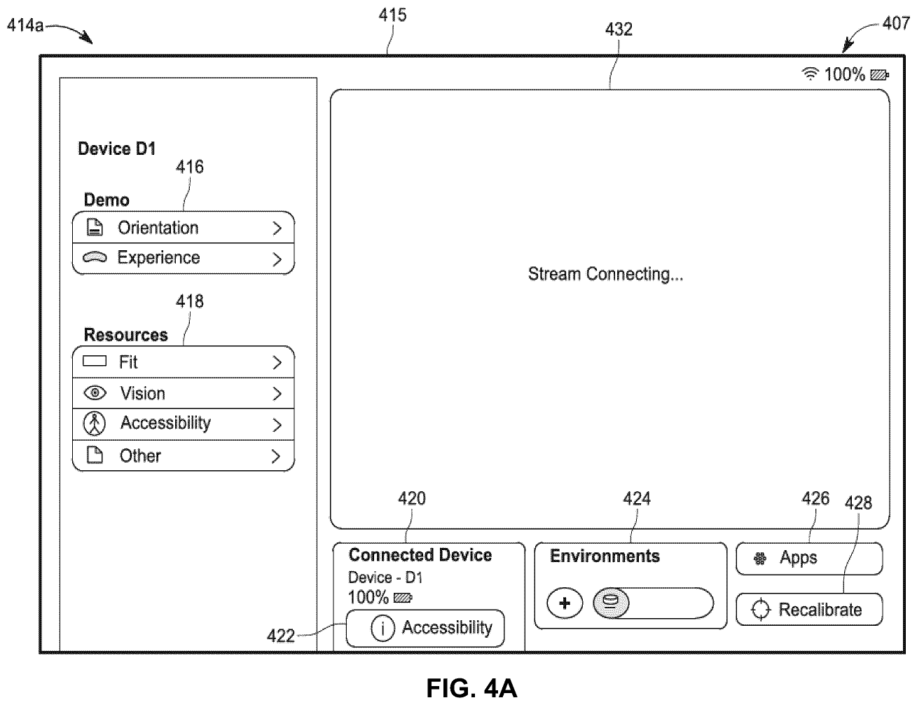

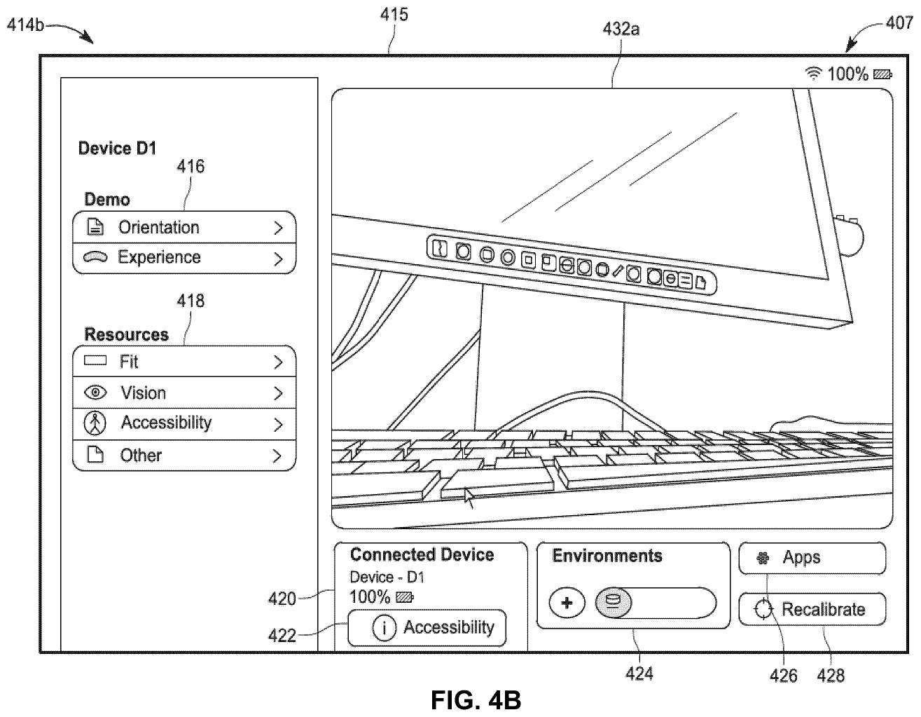

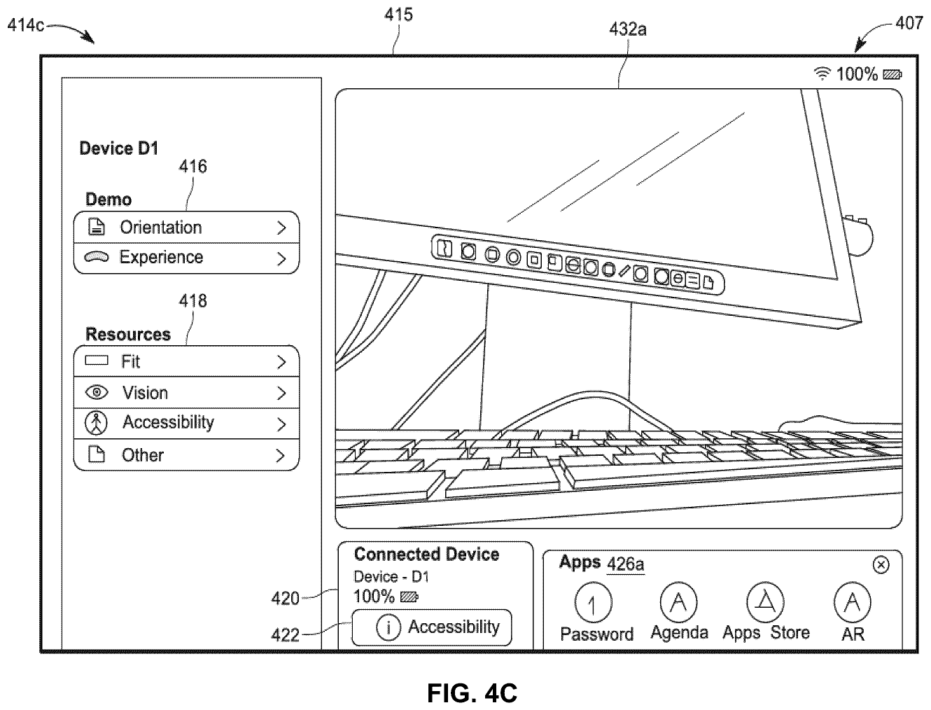

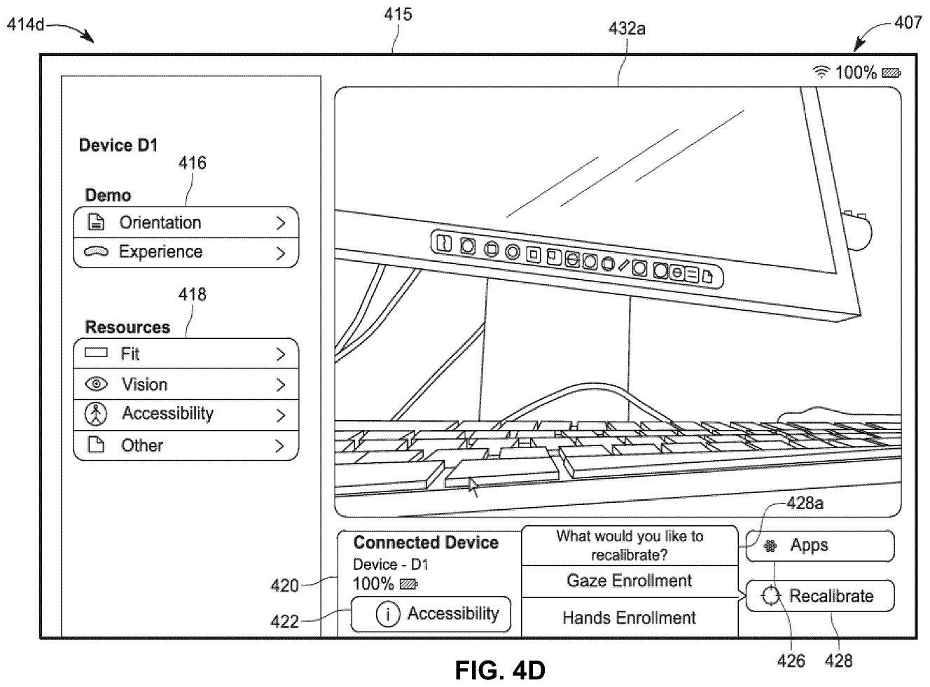

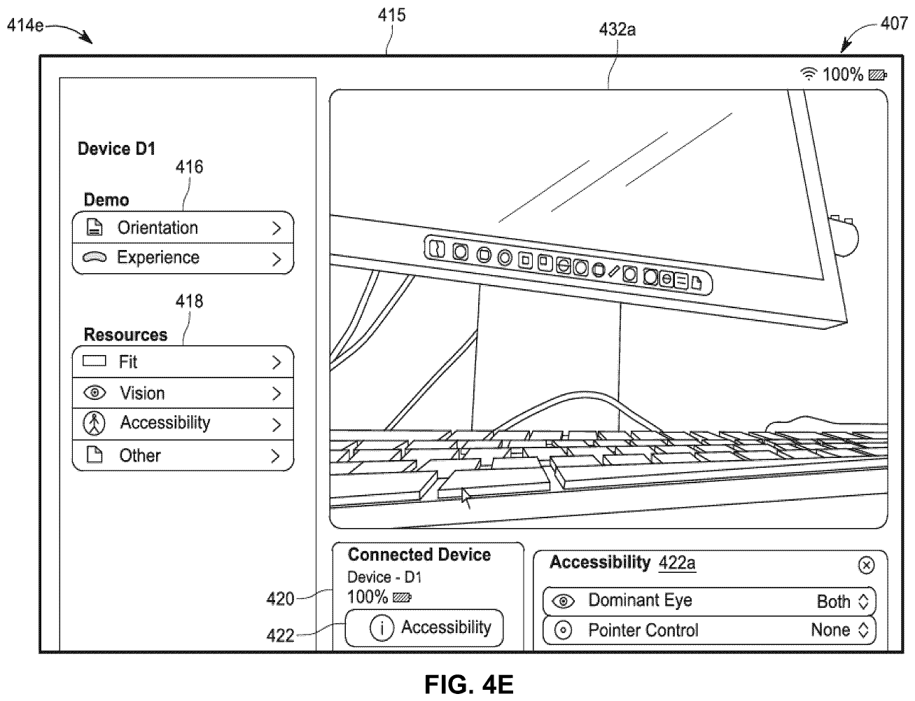

FIGS. 4A-4E illustrate exemplary views of a control interface of an electronic device, in accordance with some implementations.

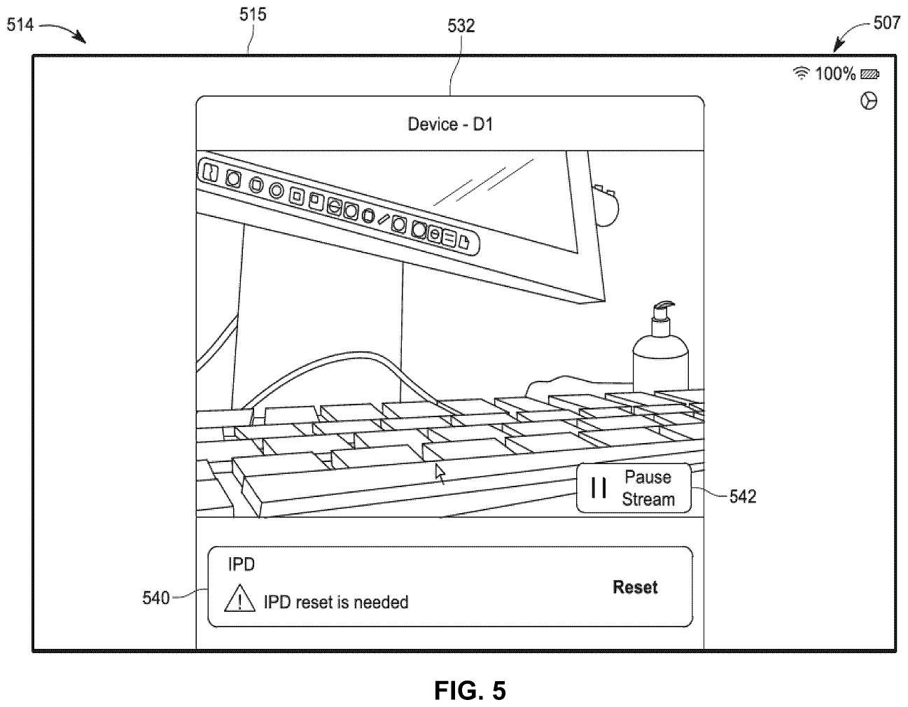

FIG. 5 illustrates an exemplary view of a control interface of a tablet providing a mirrored view of a 3D environment presented on an HMD during a demo mode, in accordance with some implementations.

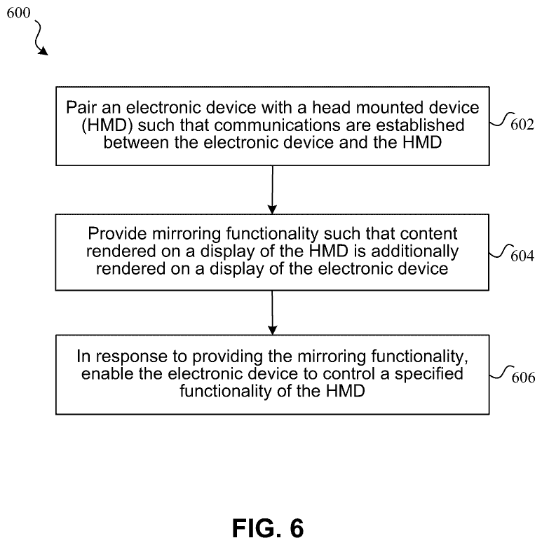

FIG. 6 is a flowchart representation of an exemplary method that enables a specialized demo portal that provides mirroring and control functionality of an HMD, in accordance with some implementations.

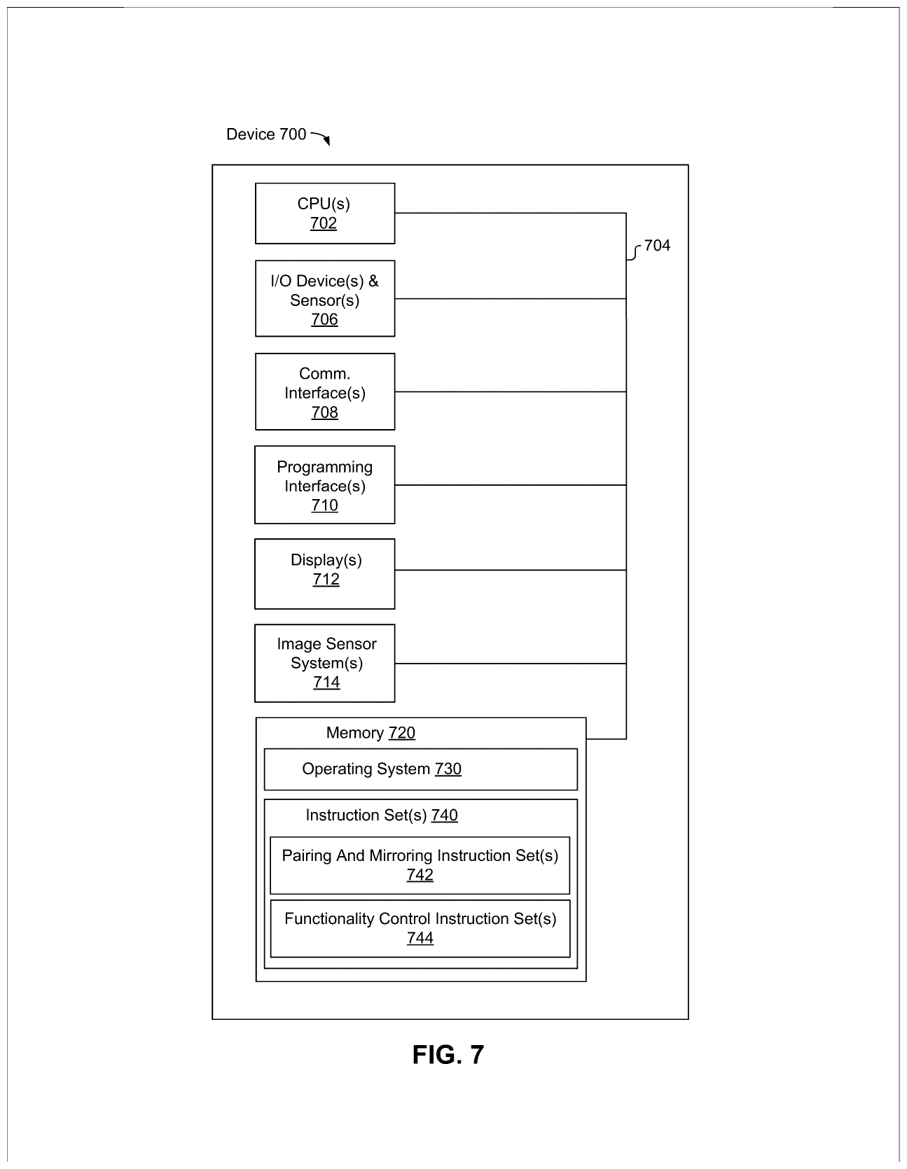

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

FIG. 1 illustrates exemplary electronic devices 105 and 110 operating in a physical environment 100. In the example of FIG. 1, the physical environment 100 is a room at a location such as a retail location. Additionally, electronic device 105 and electronic device 110 may be in communication with a backend server 112 (e.g., a virtual server). In an exemplary implementation, electronic device 105 and electronic device 110 are sharing information with backend server 112. The electronic devices 105 and 110 may include one or more cameras, microphones, depth sensors, or other sensors that can be used to capture information about and evaluate the physical environment 100 and the objects within it, as well as information about the user 102 of electronic device 110 and user 104 of electronic device 105. The information about the physical environment 100 and/or users 102 and 104 may be used to provide visual and audio content and/or to identify the current location of the physical environment 100 and/or the location of the users 102 and 104 within the physical environment 100.

In some implementations, views of an extended reality (XR) environment may be provided to one or more participants (e.g., users 102 and 104 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of users 102 and 104 based on camera images and/or depth camera images of the users 102 and 104. Such an XR environment may include virtual content that is positioned at 3D locations relative to a 3D coordinate system (i.e., a 3D space) associated with the XR environment, which may correspond to a 3D coordinate system of the physical environment 100.

In some implementations, electronic device 110 is configured with a specialized demo portal (e.g., enabled via a specialized interface) configured to provide mirroring and control functionality between electronic device 110 (e.g., a tablet) and electronic device 105 (e.g., HMD) such that electronic device 110 is provided with a mirrored view of a display of electronic device 105. Likewise, the mirrored view allows an operator (e.g., user 102) of electronic device 110 to control features, of electronic device 105, thereby enabling a retail associate (i.e., user 102) to help a customer (e.g., user 104) to view and learn features associated with operation of electronic device 105. For example, the mirrored view allows the operator of electronic device 110 to view and control features of device 105 such as, inter alia, opening and closing applications of device 105, controlling volume settings of device 105, controlling environments such as a background, etc. of device 105, recalibrating features of device 105 such as hand tracking, gaze tracking, interpupillary distance (IPD), etc.

The mirroring and control functionality between electronic devices 105 and 110 may be initialized via an automated pairing process that does not require manually entering a code for enabling electronic devices 105 and 110 to pair and enable communications between electronic devices 105 and 110. In contrast to a manual pairing process, electronic devices 105 and 110 are both registered with backend server 112 (e.g., exchanging a pairing sequence via backend server 112) such that the pairing, mirroring, and control functionality may be initialized via a tap or touch between electronic devices 105 and 110 and/or via a process for selecting an HMD (e.g., electronic device 105) from a list of proximate HMDs.

The mirroring and control functionality may include multiple modes, such as a normal consumer mode that includes a set of mirroring features and a demo mode that includes a different set of mirroring features. Likewise, a mode (e.g., a demo mode associated with a demo of a product or process) may only be available with respect to a specified context such as, for example, electronic device 105 being registered as a demo device located at a retail location and may be paired via a specified technique such as selecting electronic device 105 from a list of proximate electronic devices such as HMDs.

FIG. 2 illustrates an exemplary view 200 of a control interface 201 (e.g., a demo portal) of an electronic device such as a tablet (e.g., electronic device 110 of FIG. 1) for enabling control of a device such as an HMD (e.g., electronic device 105 of FIG. 1) during a demo mode, in accordance with some implementations. In some implementations, control interface 201 provides a mirrored view 208 of passthrough video being viewed by a user of the HMD. Likewise, control interface 201 provides information identifying the HMD and an indicator 207 displaying an associated Wi-Fi signal strength and battery charge percentage associated with the HMD. Control interface 201 further provides controls for enabling a user (e.g., a sales associate) of the tablet to provide control functionality associated with features of the HMD being operated by a user (e.g., a customer) requesting a demo associated with operation of the HMD. For example, when a user such as a sales or tech support representative enables a control action of control interface 201, a related command may be transmitted directly from the tablet to the HMD to execute a corresponding control action such as opening or closing an application, etc. Alternatively, when a user such as a sales or tech support representative enables a control action of control interface 201, a related command may be transmitted from the tablet to the HMD via a backend server to execute a corresponding control action such as opening or closing an application, etc. Controls (of control interface 201) for enabling the user of the tablet to provide control functionality of the HMD may include, inter alia, device feature controls 202 (e.g., associated with photo features, copresence features, and arcade features) and fit and support controls 204 associated with control of device fit features and gaze enrollment features. Likewise, controls (of control interface 201) for enabling the user the tablet to provide control functionality of the HMD may further include, inter alia, indicators and controls 210 associated with open applications, indicators and controls 212 associated with closed applications, a control 214 associated with disconnecting the tablet from the HMD, a control 216 for pausing a video stream being presented via the HMD, a pass through video control 218, a system volume control 220, a recalibration control 224, and an environment control 226.

FIG. 3 illustrates an exemplary view 300 of a control interface 301 of an electronic device such as a tablet for enabling a pairing process with a device such as an HMD, in accordance with some implementations. Control interface 301 provides a drop-down menu 304 for selecting an HMD (e.g., device D1) from a list of known proximate HMDs (or other types of devices). Control interface 301 additionally provides a drop-down menu 308 of additional devices (e.g., mobile device 1) from a list of unknown proximate devices. Likewise, control interface 301 provides information identifying the HMD and an indicator 307 displaying an associated Wi-Fi signal strength and battery charge percentage associated with the HMD. A connect button of control interface 301 is configured to activate a pairing process between the tablet and a device selected from drop-down menu 304 and/or drop-down menu 308.

FIGS. 4A-4E illustrate exemplary views of a control interface 315, in accordance with some implementations.

FIG. 4A illustrates an exemplary view 414a of a control interface 415 of an electronic device, such as a tablet, for connecting to a device such as an HMD to provide a mirrored view of a three-dimensional (3D) environment comprising pass through video, applications, images and/or 3D objects presented on the HMD during a demo mode. View 414a of control interface 415 illustrates a view 432 of the tablet being connected to a 3D environment (during a pairing process) of the HMD to provide the mirrored view as illustrated in FIGS. 4B-4E, infra. Control interface 415 provides information identifying the HMD and an indicator 407 displaying an associated Wi-Fi signal strength and battery charge percentage associated with the HMD. Control interface 415 provides controls for enabling a user (e.g., a sales associate) of the tablet to provide control functionality associated with features of the HMD being operated by a user (e.g., a customer) requesting a demo associated with operation of the HMD. Controls (of control interface 415) for enabling the user of the tablet to provide control functionality of the HMD may include, inter alia, demo controls 416 (e.g., associated with an orientation and experience of the demo) and resource controls 418 (e.g., associated with control of resources of the HMD such as a fit, vision attributes, accessibility attributes, and additional attributes). Likewise, controls (of control interface 415) for enabling the user the tablet to provide control functionality of the HMD may further include, inter alia, an indicator 420 displaying a connected device (e.g., device D1), an accessibility control 422 for controlling accessibility features of the HMD, an environments control 425 for controlling environments (e.g., a background, etc.) of the HMD, a control 426 associated with control of applications of the HMD, and a recalibration control 428 for recalibrating features of the HMD.

FIG. 4B illustrates an exemplary view 414b of control interface 415 subsequent to the tablet being connected to the HMD to provide a mirrored view 432a of a three-dimensional (3D) environment comprising pass through video, applications, images and/or 3D objects presented on the HMD during the demo mode.

FIG. 4C illustrates an exemplary view 414c of control interface 415 providing mirrored view 432a of the three-dimensional environment presented on the HMD during the demo mode. Likewise, view 414c of control interface 415 provides an expanded view 426a of the applications control 426 illustrated with respect to FIG. 4B, supra. Expanded view 426a illustrates applications associated with password control, agenda control, an application store, and an augmented reality (AR) control.

FIG. 4D illustrates an exemplary view 414d of control interface 415 providing mirrored view 432a of the three-dimensional environment presented on the HMD during the demo mode. Likewise, view 414d of control interface 415 provides an expanded view 428a of the recalibration control 428 illustrated with respect to FIG. 4B, supra. Expanded view 428a illustrates controls for recalibrating gaze enrollment features and hand enrollment features.

FIG. 4E illustrates an exemplary view 414e of control interface 415 providing mirrored view 432a of the three-dimensional environment presented on the HMD during the demo mode. Likewise, view 414e of control interface 415 provides an expanded view 422a of the accessibility control 428. Expanded view 428a illustrates controls for accessibility features such as dominate eye features and pointer control features.

FIG. 5 illustrates an exemplary view 514 of a control interface 515 of a tablet providing a mirrored view 532 of a 3D environment presented on an HMD during a demo mode, in accordance with some implementations. Control interface 515 provides information identifying the HMD and an indicator 507 displaying an associated Wi-Fi signal strength and battery charge percentage associated with the HMD. Control interface 515 provides controls for enabling a user of the tablet to provide control functionality associated with features of the HMD being operated by a user requesting a demo associated with operation of the HMD. Controls (of control interface 515) for enabling the user of the tablet to provide control functionality of the HMD may include, inter alia, an IPD reset control 540 for controlling an IPD of the HMD with respect to the user and a pause stream control 542 or pausing a video stream associated with presentation of the 3D environment.

FIG. 6 is a flowchart representation of an exemplary method 600 that enables a specialized demo portal that provides mirroring and control functionality of an HMD such that content rendered on a display of the HMD is additionally rendered on a display of an electronic device (e.g., a tablet) thereby allowing an operator of the electronic device to control specified features of the HMD, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 pairs the electronic device with an HMD such that communications are established between the electronic device and the HMD.

In some implementations, the pairing process is permitted based on determining that the electronic device and an HMD are registered with a same system such as a backend server (e.g., backend server 112) as described with respect to FIG. 1.

In some implementations, pairing the electronic device with the HMD is automatically initiated in response to physical contact made between the electronic device and the HMD and/or in response to wireless communications (e.g., Bluetooth or near field communications (NFC)) initiated between the electronic device and the HMD. In some implementations, pairing the electronic device with the HMD is automatically initiated in response to a selection of the HMD from a list of HMDs located within a proximity of the electronic device. For example, a control interface 301 may be implemented to provide a drop-down menu 304 for selecting an HMD from a list of known proximate HMDs as described with respect to FIG. 3.

At block 604, the method 600 provides mirroring functionality such that content rendered on a display of the HMD is additionally rendered on a display of the electronic device. For example, a mirrored view 432a may be provided as described with respect to FIG. 4B.

In some implementations, the mirroring functionality may be permitted based on determining that the electronic device and an HMD are registered with a same system such as a backend server (e.g., a virtual hub) as described with respect to FIG. 1.

In some implementations, the mirroring functionality may be enabled based on receiving, from the HMD, a request for assistance associated with operation of the HMD. For example, a customer at a retail location may make a request to a sales associate for help with operation of the HMD. For example, a customer may request a demo associated with operation of the HMD as described with respect to FIG. 2.

In some implementations, content rendered on the display of the HMD and the display of the electronic device may include a view of a 3D environment that includes applications, images or 3D objects. For example, a mirrored view 432a of a 3D environment as described with respect to FIG. 4B.

At block 606, in response to providing the mirroring functionality, the method 600 enables the electronic device to control a specified functionality of the HMD. The specified functionality of the HMD being controlled by the electronic device may include, inter alia, opening and closing applications of the HMD, controlling volume functions of the HMD, controlling environments (e.g., a background, etc.) of the HMD, controlling brightness or contrast functions of the HMD, controlling accessibility functions of the HMD (e.g., enhancement functionality associated with vision, hearing, dexterity, or mobility impairments such as text to voice or speech recognition functionality), recalibrating hand tracking of the HMD (e.g., hand functionality), recalibrating gaze tracking of the HMD (e.g., gaze functionality, etc.), recalibrating an interpupillary distance (IPD) of the HMD, etc. as described with respect to FIGS. 4A-4E, supra.

In some implementations, controlling the specified functionality of the HMD may be performed according to a selected mode of a plurality of available modes. For example, a selected mode may include a normal consumer mode including a set of mirroring features, a demo mode including a different set of mirroring features, etc. The selected mode may be enabled with respect to a specified context. For example, the HMD may be registered as a demo device, located in a retail location, paired via a particular technique, etc.

FIG. 7 is a block diagram of a device 700. Device 700 illustrates an exemplary device configuration for electronic device 105 or 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more output device(s) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 712 include one or more displays configured to present a view of a 3D environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 712 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 712 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a pairing and mirroring instruction set 742 and a functionality control instruction set 744. The instruction set(s) 740 may be embodied as a single software executable or multiple software executables.

The pairing and mirroring instruction set 742 is configured with instructions executable by a processor to enable pairing and mirroring functionality between a device such as a tablet and a device such as an HMD.

The functionality control instruction set 744 is configured with instructions executable by a processor to control HMD functionality/features such as opening/closing apps, controlling volume, controlling environments (e.g., a background, etc.), recalibration of HMD features such as hand or gaze tracking, etc.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a processor of an electronic device:
pairing the electronic device with a head mounted device (HMD) such that communications are established between the electronic device and the HMD;
providing mirroring functionality such that content rendered on a display of the HMD is additionally rendered on a display of the electronic device; and
in response to said providing the mirroring functionality, enabling the electronic device to control a specified functionality of the HMD.

2. The method of claim 1, wherein the specified functionality of the HMD being controlled by the electronic device comprises opening and closing applications of the HMD.

3. The method of claim 1, wherein the specified functionality of the HMD being controlled by the electronic device comprises controlling volume functions of the HMD.

4. The method of claim 1, wherein the specified functionality of the HMD being controlled by the electronic device comprises controlling environments of the HMD.

5. The method of claim 1, wherein the specified functionality of the HMD being controlled by the electronic device comprises controlling brightness or contrast functions of the HMD.

6. The method of claim 1, wherein the specified functionality of the HMD being controlled by the electronic device comprises controlling accessibility functions of the HMD.

7. The method of claim 1, wherein the specified functionality of the HMD being controlled by the electronic device comprises recalibrating hand tracking of the HMD.

8. The method of claim 1, wherein the specified functionality of the HMD being controlled by the electronic device comprises recalibrating gaze tracking of the HMD.

9. The method of claim 1, wherein the specified functionality of the HMD being controlled by the electronic device comprises recalibrating an interpupillary distance (IPD) of the HMD.

10. The method of claim 1, wherein the mirroring functionality is permitted based on determining that the electronic device and the HMD are registered with a same system.

11. The method of claim 1, wherein the pairing is permitted based on determining that the electronic device and the HMD are registered with a same system.

12. The method of claim 1, wherein the mirroring functionality is enabled based on receiving, from the HMD, a request for assistance associated with operation of the HMD.

13. The method of claim 1, wherein said pairing the electronic device with the HMD is automatically initiated in response to a physical contact made between the electronic device and the HMD.

14. The method of claim 1, wherein said pairing the electronic device with the HMD is automatically initiated in response to wireless communications initiated between the electronic device and the HMD.

15. The method of claim 1, wherein said pairing the electronic device with the HMD is automatically initiated in response to a selection of the HMD from a list of HMDs located within a proximity of the electronic device.

16. The method of claim 1, wherein the content rendered on the display of the HMD and the display of the electronic device comprises a view of a three dimensional environment comprising applications, images or 3D objects.

17. The method of claim 1, wherein controlling the specified functionality of the HMD may be performed according to a selected mode of a plurality of available modes.

18. The method of claim 17, wherein the selected mode is enabled with respect to a specified context.

19. A system comprising:
a processor;
a computer readable medium storing instructions that when executed by the processor cause the processor to perform operations comprising:
pairing the electronic device with a head mounted device (HMD) such that communications are established between the electronic device and the HMD;
providing mirroring functionality such that content rendered on a display of the HMD is additionally rendered on a display of the electronic device; and
in response to said providing the mirroring functionality, enabling the electronic device to control a specified functionality of the HMD.

20. A non-transitory computer-readable medium comprising instructions that when executed by a processor cause the processor to perform operations comprising:
pairing the electronic device with a head mounted device (HMD) such that communications are established between the electronic device and the HMD;
providing mirroring functionality such that content rendered on a display of the HMD is additionally rendered on a display of the electronic device; and
in response to said providing the mirroring functionality, enabling the electronic device to control a specified functionality of the HMD.
